(19) United States
(12) Patent Application Publication
(10) Pub. No.: US 2010/0248006 A1
(43) Pub. Date: Sep. 30, 2010

(54) Battery Module

(76) Inventor: Chia-Han Chan, Tu-Cheng City (TW)

Correspondence Address: LIN & ASSOCIATES INTELLECTUAL PROPERTY, INC., P.O. BOX 2339, SARATOGA, CA, 95070-0339, US

(21) Appl. No.: 12/413,602

(22) Filed: Mar. 30, 2009

(51) Int. Cl. H01M 6/42

(52) U.S. Cl. 429/159

(57) ABSTRACT

A battery module includes a base device, a plurality of battery groups and a plurality of protecting circuit groups. The base device has a positive plate and a negative plate spaced from the positive plate. The battery groups are parallel-connected between the positive plate and the negative plate, each of which has a plurality of unit cells connected in series. Each of the protecting circuit groups is connected with the battery group and has a plurality of connecting terminals. The positive pole and the negative pole of each of the unit cells of the battery group are connected with the corresponding connecting terminals of the protecting circuit group. Therefore, the failed battery group or unit cell can be timely detected by the protecting circuit group so as to ensure the reliability and product life of the battery module.

### BACKGROUND OF THE INVENTION

1. Field of the Invention

The present invention generally relates to a battery module, and more particularly to a battery module having an improved structure for electrically connecting a plurality of unit cells.

2. The Related Art

With the development of electrical technology, a battery module has been widely used in our daily life. For example, the battery module is used in a hybrid automobile for combining a motor so as to reduce environmental pollution and oil consumption. Referring to FIG. 3, a traditional battery module 40 includes a plurality of serial battery groups 41. Each of the battery groups 41 includes a plurality of parallel unit cells 42. However, because the unit cells 42 of each battery group 41 are connected in parallel, if one of the unit cells 42 is out of order, the failure of the corresponding battery group 41 having the failed unit cell 42 therein may not be timely detected. Such situation may not be aware until all of the unit cells 42 of the battery group 41 are failed. As a result, the failed unit cell 42 can't be timely detected. It may result in damaging the battery module 40 and shortening the service life.

### SUMMARY OF THE INVENTION

An object of the present invention is to provide a battery module including a base device, a plurality of battery groups and a plurality of protecting circuit groups. The base device has a positive plate and a negative plate spaced from the positive plate. The battery groups are parallel-connected between the positive plate and the negative plate and each has a plurality of unit cells connected in series. Each of the protecting circuit groups is connected with the battery group and has a plurality of connecting terminals. The positive pole and the negative pole of each of the unit cells of the battery group are connected with the corresponding connecting terminals of the protecting circuit group.

As described above, the battery groups are parallel-connected between the positive plate and the negative plate, the unit cells of each battery group are connected together in series and are further connected with the protecting circuit group. Therefore, which battery group and unit cell are out of order can be timely detected by the protecting circuit group so as to ensure the reliability and product life of the battery module.

### BRIEF DESCRIPTION OF THE DRAWINGS

The present invention will be apparent to those skilled in the art by reading the following description of a preferred embodiment thereof, with reference to the attached drawings, in which:

FIG. 1 is a view of a battery module of the present invention;

FIG. 2 is a view showing that a battery group of the battery module is connected with a protecting circuit group of the battery module; and

FIG. 3 is a view of a traditional battery module.

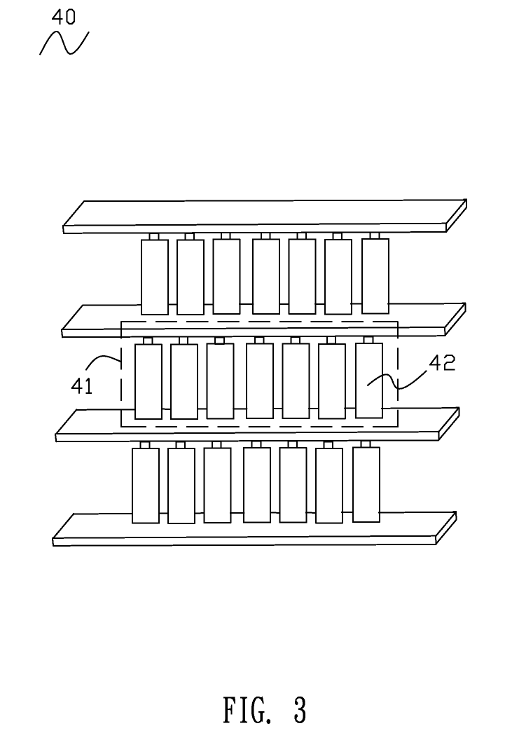

### DETAILED DESCRIPTION OF THE PREFERRED EMBODIMENT

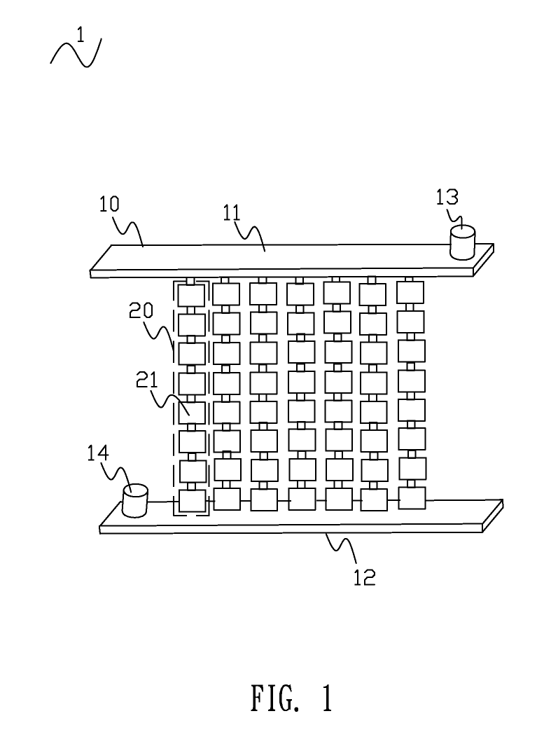

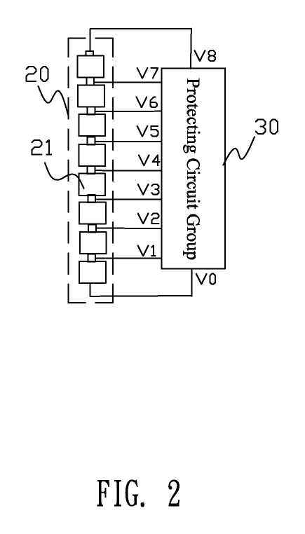

With reference to FIG. 1 and FIG. 2, a battery module 1 according to the present invention includes a base device 10, a plurality of battery groups 20 and a plurality of protecting circuit groups 30.

Referring to FIG. 1, the base device 10 includes a rectangular positive plate 11 and a rectangular negative plate 12 disposed face-to-face to space from each other. The positive plate 11 and the negative plate 12 are made of metal material of nickel. A cylindrical positive connecting portion 13 protrudes from one end of the upper side of the positive plate 11, and a cylindrical negative connecting portion 14 protrudes from the other end of the upper side of the negative plate 12. The positive connecting portion 13 and the negative connecting portion 14 are used to be electrically connected with an exterior circuit (not shown).

Referring to FIG. 1 again, each of the battery groups 20 has a plurality of unit cells 21 connected in series and arranged as a string. The battery groups 20 are parallel-connected between the positive plate 11 and the negative plate 12 and parallel to each other. Therefore, each of the battery groups 20 has an equal resistance. Moreover, the battery groups 20 are disposed between the positive connecting portion 13 and the negative connecting portion 14 to ensure a substantially equal current to pass through every battery group 20 and improve the charging and discharging efficiency of the battery groups 20 and the base device 10.

Referring to FIG. 2, the protecting circuit groups 30 respectively correspond to the battery groups 20 and each has a plurality of connecting terminals. The positive pole and the negative pole of each of the unit cells 21 of the battery group 20 are electrically connected with the corresponding connecting terminals of the protecting circuit group 30 so as to be monitored the voltage and current thereof and further detect the working state of the corresponding battery group 20. For the unit cells 21 of each battery group 20 are connected in series, if any unit cell 21 is out of order, then the failure of the corresponding battery group 20 can be timely detected by the corresponding protecting circuit group 30. Moreover, the failed unit cell 21 can be further detected by the protecting circuit group 30 according to the change of the voltage and current thereof.

As described above, the battery groups 20 are parallel-connected between the positive plate 11 and the negative plate 12, the unit cells 21 of each battery group 20 are connected together in series and are further connected with the corresponding protecting circuit group 30. Therefore, which battery group 20 and unit cell 21 are out of order can be timely detected by the protecting circuit group 30 so as to ensure the reliability and product life of the battery module 1.

What is claimed is:

1. A battery module, comprising:
a base device having a positive plate and a negative plate spaced from the positive plate;
a plurality of parallel-connected battery groups disposed between the positive plate and the negative plate, each of the battery groups having a plurality of unit cells connected in series; and
a plurality of protecting circuit groups connected with the battery groups respectively, each of the protecting circuit groups having a plurality of connecting terminals, the positive pole and the negative pole of each of the unit cells of the battery group being connected with the corresponding connecting terminals of the protecting circuit group.

2. The battery module as claimed in claim 1, wherein the positive plate and the negative plate are disposed face-to-face, the unit cells of each of the battery groups are arranged as a string, the battery groups are parallel to each other between the positive plate and the negative plate.

3. The battery module as claimed in claim 2, wherein a positive connecting portion protrudes from one end of the positive plate, and a negative connecting portion protrudes from the other end of the negative plate, the battery groups are disposed between the positive connecting portion and the negative connecting portion.
